(19) United States
(12) Patent Application Publication
(10) Pub. No.: US 2024/0384490 A1
(43) Pub. Date: Nov. 21, 2024

(54) BATTERY POWERED POLE TAMPER

(71) Applicant: MILWAUKEE ELECTRIC TOOL CORPORATION, Brookfield, WI (US)

(72) Inventors: Garrett P. Mitchell, Milwaukee, WI (US); Evan M. Glanzer, Milwaukee, WI (US); Joseph W. Miller, Waukesha, WI (US); Joseph C. Reiter, Milwaukee, WI (US); David M. Rose, Pewaukee, WI (US)

(21) Appl. No.: 18/663,218

(22) Filed: May 14, 2024

Related U.S. Application Data
(60) Provisional application No. 63/467,776, filed on May 19, 2023.

(51) Int. Cl. E02D 3/046

(52) U.S. Cl. CPC E02D 3/046; E02D 2600/10; E02D 2600/40

(57) ABSTRACT

A pole tamper may include a handle. A pole tamper may include a motor supported by the handle and operably coupled to a battery pack to receive electrical current therefrom. A pole tamper may include a shoe movably supported by the handle. A pole tamper may include a drive mechanism operably coupled to the motor, the drive mechanism configured to move the shoe in a reciprocating manner.

This application claims priority to U.S. Provisional Patent Application No. 63/467,776 filed on May 19, 2023, the entire contents of which is incorporated herein by reference.

### BACKGROUND OF THE INVENTION

Pole tampers are typically used to compact soil around utility poles during installation. Such pole tampers are typically powered by hydraulics or from large air compressors. Both methods require large power sources and long hoses that can pose safety hazards when working around utility lines.

### SUMMARY OF THE INVENTION

In some aspects, the techniques described herein relate to a pole tamper including: a handle; a motor supported by the handle and operably coupled to a battery pack to receive electrical current therefrom; a shoe movably supported by the handle; and a drive mechanism operably coupled to the motor, the drive mechanism configured to move the shoe in a reciprocating manner.

In some aspects, the techniques described herein relate to a pole tamper including: a handle; a motor supported by the handle; a shoe supported by the handle; a drive mechanism operably coupled to the motor, the drive mechanism configured to move the shoe in a reciprocating manner; a remote power unit unsupported by the handle; and a cable configured to transmit electrical current from the remote power unit to the motor.

In some aspects, the techniques described herein relate to a pole tamper including: a handle; a motor supported by the handle; a shoe supported by the handle; a drive mechanism operably coupled to the motor, the drive mechanism configured to move the shoe in a reciprocating manner; and a tip detect sensor supported by the handle and configured to deactivate the motor in response to detection of the handle deviating from a substantially upright position.

Other features and aspects of the invention may be apparent upon considering the following detailed description and accompanying drawings.

### BRIEF DESCRIPTION OF THE DRAWINGS

FIG. 1 is a schematic view of a pole tamper according to an embodiment of the disclosure.

FIG. 2 is a schematic view of a pole tamper according to another embodiment of the disclosure.

FIG. 3 is a schematic view of the pole tamper of FIG. 1 or 2 and including a first power source configuration.

FIG. 4 is a schematic view of the pole tamper of FIG. 1 or 2 and including a second power source configuration.

FIG. 5 is a schematic view of the pole tamper of FIG. 1 or 2 and including a third power source configuration.

FIG. 6 is a schematic view of the pole tamper of FIG. 1 or 2 and including a fourth power source configuration.

FIG. 7 is a schematic view of the pole tamper of FIG. 1 or 2 and including a fifth power source configuration.

FIG. 8 is a schematic view of the pole tamper of FIG. 1 or 2 and including a sixth power source configuration.

FIG. 9 is a schematic view of the pole tamper of FIG. 1 or 2 and including a first sensor configuration.

FIG. 10 is a schematic view of the pole tamper of FIG. 1 or 2 and including a second sensor configuration.

FIG. 11 is a schematic view of a pole tamper including a handle according to an embodiment of the disclosure.

FIG. 12 is a schematic view of a pole tamper including a handle according to another embodiment of the disclosure.

FIG. 13 is a schematic view of a pole tamper including a handle according to another embodiment of the disclosure.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting.

### DETAILED DESCRIPTION

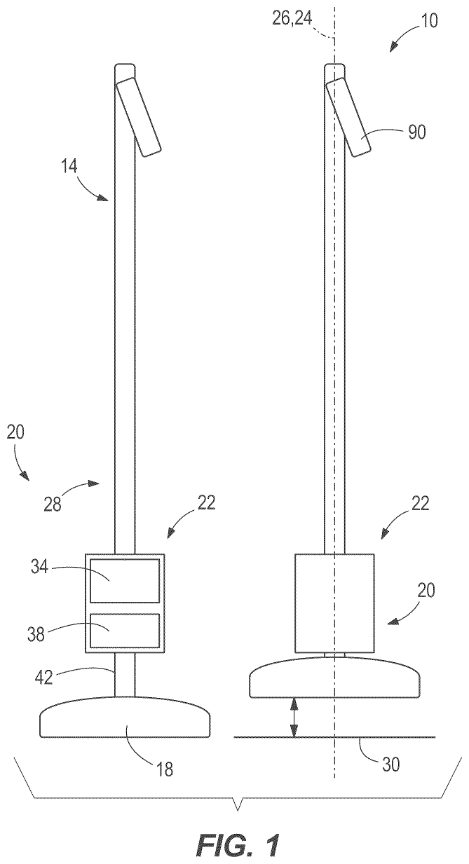

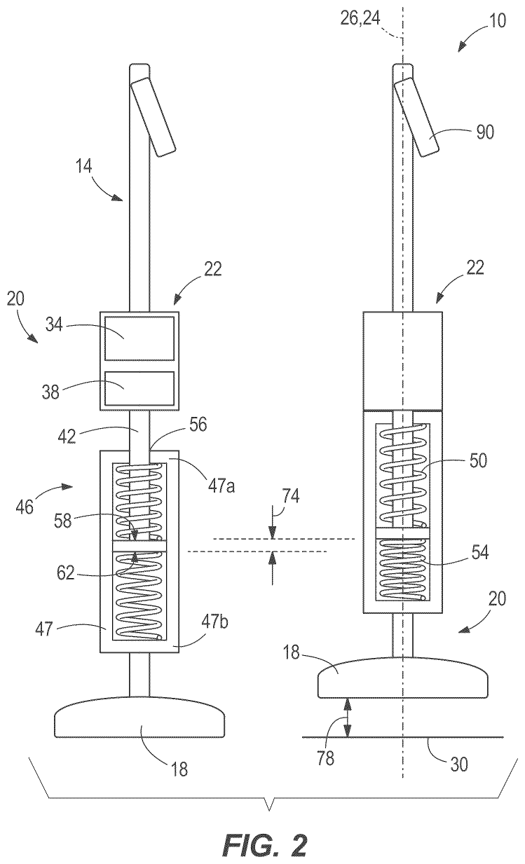

FIGS. 1-2 illustrate embodiments of a power tool. The power tool is a pole tamper 10 including a handle 14, a shoe 18 coupled to and movable relative to the handle 14, and a percussion mechanism 20 supported by the handle 14 and configured to move the shoe 18 in a reciprocating manner. The handle 14 defines a longitudinal axis 26. When in operation, the pole tamper 10 is in an upright position 28 such that the longitudinal axis 26 is oriented transverse to a ground surface 30. The shoe 18 moves reciprocally along the longitudinal axis 26. In the illustrated embodiment, the percussion mechanism 20 includes a drive mechanism 22. The percussion mechanism 22 includes a motor 34 that is supported by the handle 14. In some embodiments, the motor 34 may be a brushless DC motor. In alternate embodiments, the motor 34 may be a solenoid or linear motor. The handle 14 is operably coupled to the percussion mechanism 20, and the percussion mechanism 20 moves the shoe 18 relative to the handle 14.

In some embodiments, the drive mechanism 22 may include a crank mechanism 38 coupled to the shoe 18 and a gearset (not shown) operably coupled to the motor 34, which drives the crank mechanism 38 to move the shoe 18 in a reciprocating manner along the longitudinal axis 26. In some embodiments, the gearset may be a reduction gearset so the shoe 18 reciprocates at a frequency that is lower than a rotational frequency of an output shaft of the motor 34.

In the illustrated embodiments, the crank mechanism 38 may include a piston 42 or drive rod that reciprocates in response to torque received from the motor 34. The piston 42 is operably coupled to the shoe 18. In the illustrated embodiment, an axis 44 of the piston 42 is coaxial with the longitudinal axis 26.

In the embodiment illustrated in FIG. 1, the piston 42 is directly coupled to the shoe 18. When the piston 42 is directly coupled with the shoe 18, the drive mechanism 22 operates the piston 42 in a reciprocating manner between a retracted position and an extended position. When the piston 42 reciprocates with a displacement of one inch, the piston 42 reciprocates the shoe 18 with an equivalent displacement.

In the embodiment illustrated in FIG. 2, the percussion mechanism 20 further includes a tube-spring mechanism 46. As shown, the shoe 18 is coupled to a tube-spring mechanism 46 that is movably coupled to the piston 42. The tube-spring mechanism 46 includes a housing 47, a first spring 50 positioned within the housing 47, and a second spring 54 positioned within the housing 47. As shown, the first and second springs 50, 54 are in series with one another. The housing 47 includes a first end 47a and a second end 47b opposite the first end 47a. The first end 47a includes an opening 56 configured to receive the piston 42 and the second end 47b is coupled to the shoe 18. The piston 42 includes a first engagement surface 58 and a second engagement surface 62, both of which are positioned within the housing 47. The first engagement surface 58 engages with the first spring 50, and the second engagement surface 62 engages with the second spring 54. The first spring 50 is positioned between an inner surface of the housing at the first end 47a and the first engagement surface 58. The second spring 54 is positioned between an inner surface of the housing 47 at the second end 47b and the second engagement surface 62.

In operation, when the motor 34 is activated, the drive mechanism 22 operates the piston 42 in a reciprocating manner such that the piston 42 biases the first spring 50 and second spring 54, alternatively. For example, the piston 42 is reciprocable between the retracted position and an extended position. In the retracted position, the first engagement surface 58 compresses the first spring 50 and the second spring 54 is permitted to rebound, effectively applying an upward force to the housing 47 (and therefore the shoe 18) to lift the shoe 18 away from the ground surface 30. In the extended position, the second engagement surface 62 compresses the second spring 54 and the first spring 50 is permitted to rebound, effectively applying a downward force to the housing 47 (and therefore the shoe 18) to push the shoe 18 toward the ground surface 30 for a compaction event. This arrangement enables displacement of the piston 42 by a first distance 74 to result in displacement of the shoe 18 by a second distance 78 that is greater than the first distance 74 of the piston 42, which amplifies the force output of the shoe 18. For example, when the piston 42 reciprocates with a displacement (e.g., the first distance 74) of one inch, the tube-spring mechanism 46 amplifies the force and reciprocates the shoe 18 with three inches of displacement (e.g., the second distance 78). The tube-spring mechanism 46 also serves as a vibration dampening mechanism extending between the drive mechanism 22 and the piston 42.

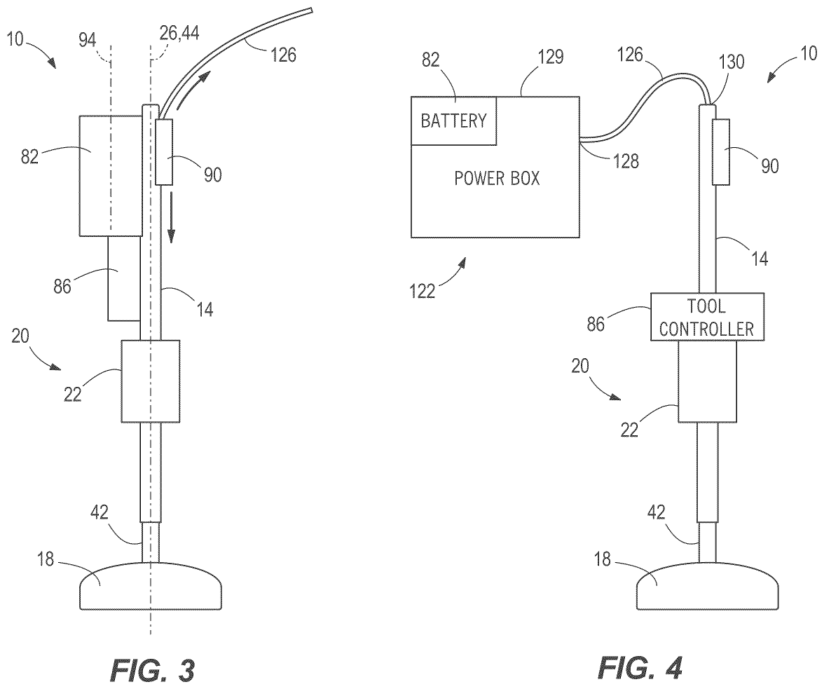

With respect to FIG. 3, the pole tamper 10 of either FIG. 1 or 2 may be configured to mechanically and electrically receive a battery pack 82. Moreover, as shown in FIG. 3, the battery pack 82 may be supported by the handle 14. In some embodiments, the handle 14 may include a battery pack receptacle (not shown) that is configured to mechanically and electrically couple the battery pack 82. When included in the pole tamper 10, the tube-spring mechanism 46 may reduce the amount of vibration on the battery pack 82 during operation of the pole tamper 10.

The pole tamper 10 may also include a motor control unit 86 supported by the handle 14 and a user interface 90 supported by the handle 14. The motor control unit 86 includes a controller that is configured to communicate with the motor 34, the battery pack 82, and the user interface 90. The controller of the motor control unit 86 may receive the user input from the user interface 90 to control the motor 34, monitor conditions of the pole tamper 10 via input from sensors, and the like. The battery pack 82 is configured to power the motor 34 in response to a user input received from the user interface 90. In the illustrated embodiment, the battery pack 82 includes a battery axis 94 that extends centrally through the battery. The battery axis 94 is substantially parallel to the longitudinal axis 26 of the pole tamper 10. In addition, the battery pack 82 is positioned on a first side of the pole tamper 10, and the user interface 90 is positioned on a second side of the pole tamper 10. In other words, the battery pack 82 is positioned on an opposite side of the longitudinal axis 26 from the user interface 90.

The user interface 90 may allow an operator to selectively provide power to the motor 34, select a mode (e.g., high, medium, or low speed) for the motor 34 to operate, monitor the state of charge of the battery pack 82, and the like. The user interface 90 may be in the form of a physical button or trigger, an actuator on a display (not shown, e.g., an LCD display), a remote, etc., that is configured to receive the user input from the operator. In some embodiments, when a display is included in the user interface 90, the display may display operational information (e.g., mode, state of charge of the battery pack 82, work time remaining, etc.). In the illustrated embodiment, the user interface 90 may be movably (e.g., slidably) connected to the handle 14 such that the user interface 90 is configured to allow a user to move or slide the user interface 90 up and down on the handle 14 along the longitudinal axis 26. Because pole tampers 10 can be inserted into holes in the ground having varying depths, a movable or slidable user interface 90 allows the user to access the user interface 90 regardless of the depth of the hole into which the pole tamper 10 is inserted.

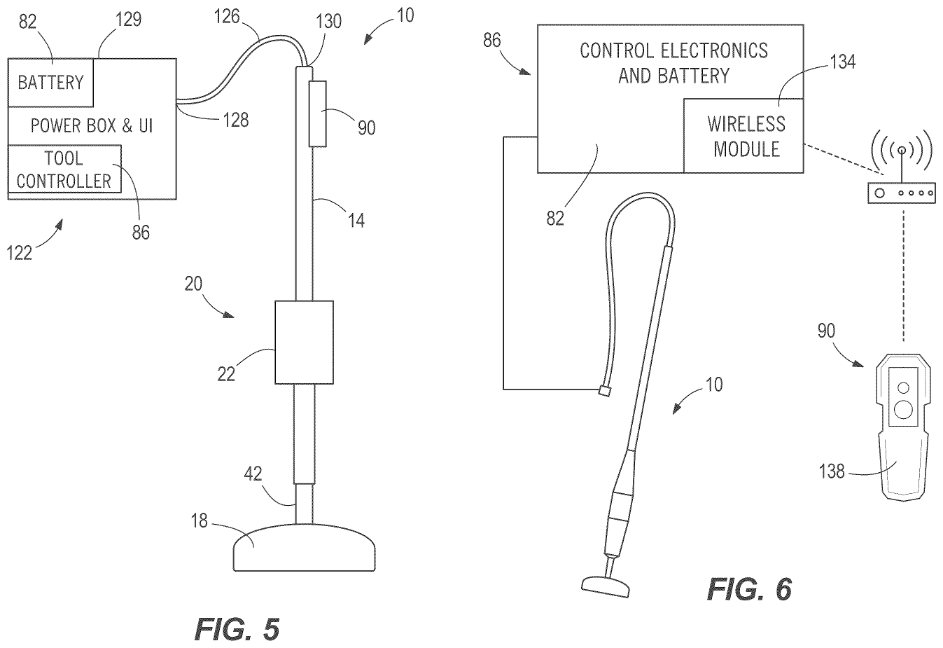

In some embodiments, as shown in FIG. 4, the motor 34 of the pole tamper 10 shown in either of FIG. 1 or 2 may be powered by a remote power unit 122, which includes the battery pack 82, and which is unsupported by the handle 14. In the embodiment of FIG. 4, the motor control unit 86 is supported by the handle 14. The remote power unit 122 may include a frame 129 with a battery receptacle (not shown) to which the battery pack 82 is attachable. In the embodiment of the FIG. 4, the battery pack 82 is in communication with the motor control unit 86 via a cable 126. The frame 129 may include an electrical connection (e.g., an electrical port, not shown) configured to selectively couple to a first end 128 of the cable 126. A second end 130 of the cable 126 may couple to an electrical connection (e.g., an electrical port, not shown) of the motor control unit 86. In the embodiment of FIG. 4, the user interface 90 may be supported by either the remote power unit 122 or the handle 14. In either case, the user interface 90 is in electrical communication with the battery pack 82 via the controller of the motor control unit 86. In operation, a user may hold the pole tamper 10 while electrical power (e.g., electrical current) is transmitted, via the cable 126, to the motor control unit 86 of the pole tamper 10. In some embodiments, as shown in FIG. 5, the motor 34 of the pole tamper 10 shown in either of FIG. 1 or 2 may be powered by the remote power unit 122, which includes the battery pack 82, the motor control unit 86, and the user interface 90. Like the power unit 122 of FIG. 4, the power unit 122 of FIG. 5 includes a frame 129 and a battery pack receptacle (not shown) to which the battery pack 82 is attachable. In the embodiment of FIG. 5, the motor control unit 86 is also supported by the frame 129. In some embodiments, the motor control unit 86 may be removably coupled to the frame (and therefore the battery pack 82) or may be a non-removable component of the power unit 122. The controller of the motor control unit 86 is configured to communicate with the user interface 90, the battery pack 82, and the motor 34. The controller of the motor control unit 86 is configured to receive the user input from the user interface 90 to control the motor 34, monitor conditions of the pole tamper 10 via input from sensors, and the like. The motor control unit 86 may include an electrical connection (e.g., an electrical port, not shown) configured to selectively couple to the first end 128 of the cable 126. In other embodiments, the frame 129 may include an electrical connection (e.g., an electrical port, not shown) configured to selectively couple to the first end 128 of the cable 126. The second end 130 of the cable 126 may couple to an electrical connection (e.g., an electrical port, not shown) of the handle 14. In other embodiments, the second end 130 of the cable 126 may couple to an electrical connection (e.g., an electrical port, not shown) of the motor 34. In operation, a user may hold the pole tamper 10 while electrical power (e.g., electrical current) and control signals are delivered, via the cable 126, to the motor 34 of the pole tamper 10 from controller of the motor control unit 86, which is communication with the battery pack 82.

As shown in FIG. 6, the controller of the motor control unit 86 (if incorporated in the remote power unit 122 of FIG. 5) may be configured to communicate with the motor 34 wirelessly, rather than via the cable 126. In such embodiment, the controller of the motor control unit 86 may include a wireless communication module 134 and the user interface 90 may include a remote pairing button (not shown). Additionally, the input device of the user interface 90 can include a wireless remote 138 that wirelessly communicates with the wireless communication module 134 of the motor control unit 86 (e.g., via BLUETOOTH or WIFI communication protocols, or the like). The remote 138 may control whether the motor control unit 86 is on or off and whether the motor 34 is on or off. To pair the remote 138 with the motor control unit 86, the user may press the remote pairing button on the user interface 90, thereby allowing wireless communication between the remote 138 and the controller of the motor control unit 86. In some embodiments, the wireless remote 138 can be operated by a separate user, allowing another user of the pole tamper 10 to use both hands to maneuver the pole tamper 10.

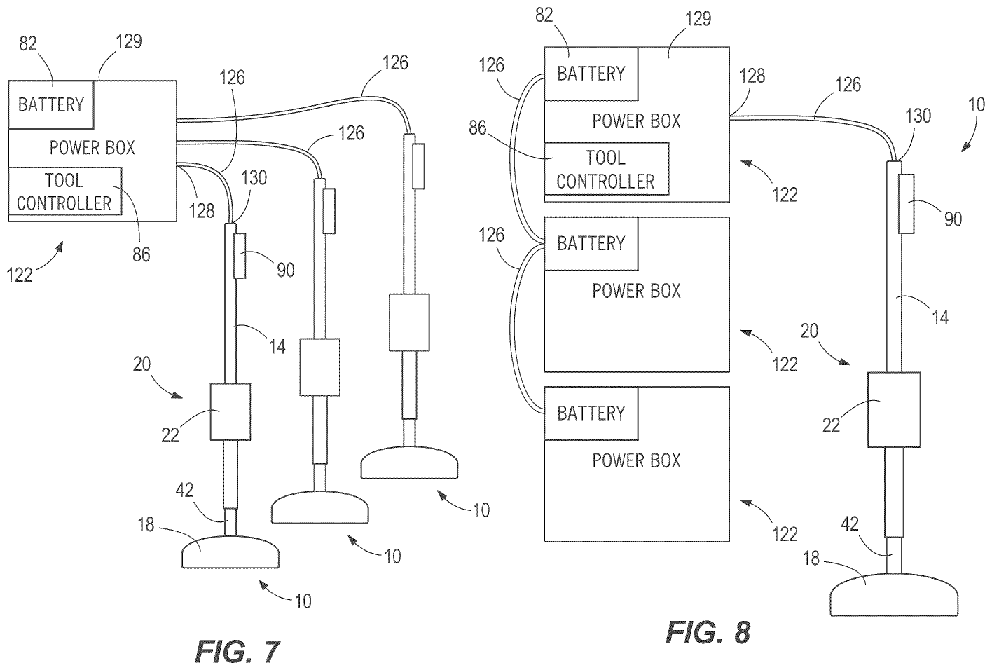

In some embodiments, as shown in FIG. 7, a single remote power unit 122 can power multiple pole tampers 10. For example, the motor control unit 86 in the remote power unit 122 may include multiple motor control units 86, each being individually connectable to one of the pole tampers 10 via a cable 126. In other embodiments, the motor control units 86 may be onboard the tampers 10, like shown in FIG. 4, instead of being centrally located within the remote power unit 122. In either case, because multiple tampers 10 can be operated at the same time from the same power source, a ground compaction event may be completed more quickly. Additionally, the remote power unit 122 can be used to power and control each of the pole tampers 10 independently or as collectively as a single unit.

FIG. 8 illustrates an embodiment of the pole tamper 10 of FIG. 1 in which a plurality of remote power units 122 may be connectable to each other to provide electrical power to a single pole tamper 10. The plurality of remote power units 122 may be electrically connected in a parallel arrangement (i.e., to increase the overall capacity of the electrical power available for use by the single pole tamper 10) or a series arrangement (i.e., to increase the voltage of the electrical power available for use by the single pole tamper 10). In this embodiment, the battery packs 82 and pole tamper 10 would be controlled by a single motor control unit 86. Connecting several remote power units 122 in a parallel arrangement increases the continuous runtime of the pole tamper 10.

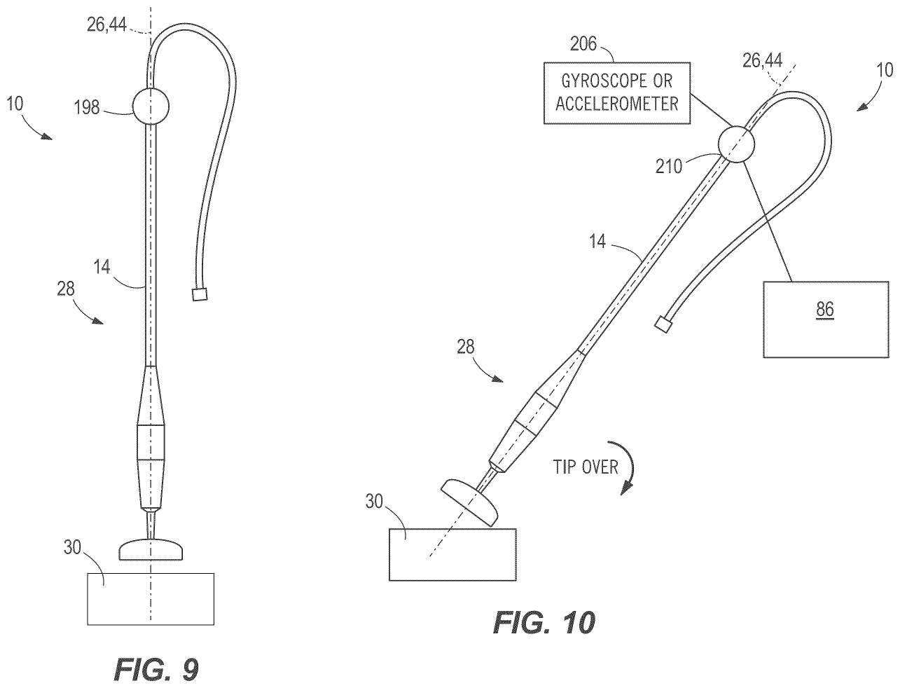

In some embodiments, such as FIG. 9, any of the disclosed pole tampers 10 disclosed herein may also include an active gyroscope 198 coupled to the handle 14 to maintain the handle 14 in an upright position. In one embodiment, the active gyroscope 198 may be a gyroscopic stabilizer configured to improve control of the tamper 10 by spinning and producing a moment of inertia. The moment of inertia produced by the active gyroscope 198 corrects a tipping force applied to the pole tamper 10, biases the pole tamper 10 to stay in the upright position 28 (e.g., such that the longitudinal axis 26 is within a predetermined angle relative to the ground 30), and absorbs and controls vibration of the pole tamper 10. The active gyroscope 198 may be mounted on a gimbal (not shown) and a gyroscope frame (not shown). The gimbal and gyroscope frame may support the gyroscope 198, which spins with a constant velocity. In another embodiment, the gyroscope 198 may spin at a constant velocity to improve stability and the gimbal may spin at a variable velocity to correct for a changing tipping force applied to the pole tamper 10. In still other embodiments, the gyroscope 198 may spin at a variable velocity to improve stability and the gimbal may spin at a constant velocity to correct for a changing tipping force applied to the pole tamper 10. In alternate embodiments, the pole tamper 10 may not use an active gyroscope 198 or may instead use one or more other stabilization methods.

Additionally or alternatively, with respect to FIG. 10, any of the pole tampers 10 disclosed herein may include a tip detect sensor 206 supported by the handle 14. In some embodiments, the tip detect sensor 206 may be an accelerometer coupled to a top portion 210 of the handle 14. In alternate embodiments, the tip detect sensor 206 may be a gyroscope or another sensor. The tip detect sensor 206 is configured to sense the position of the pole tamper 10. The tip detect sensor 206 senses when the pole tamper 10 deviates from a substantially upright position, or falls over, and communicates (as discussed in the embodiments above) with the controller of the motor control unit 86 to deactivate the pole tamper 10. That is, the tip detect sensor 206 may communicate wirelessly by way of the wireless module 134 with the controller of the motor control unit 86, as disclosed in FIG. 6, to deactivate the motor 34. In some embodiments, the tip detect sensor 206 may communicate with the on-board controller of the motor control unit 86, such as disclosed in FIGS. 3 and 4, to deactivate the motor 34. In still other embodiments, the tip detect sensor 206 may communicate via the cable 126 with controller of the motor control unit 86 of the remote power unit 122, such as disclosed in FIG. 5, to deactivate the motor 34.

In any of the embodiments herein, a motor current sensor and a motor voltage sensor may be in communication with the controller of the motor control unit. The motor current sensor and the motor voltage sensor are used to maintain either a predetermined output speed of the shoe 18 or a predetermined output power of the battery pack 82.

To maintain a predetermined output speed, the motor current and motor voltage are monitored based on predetermined thresholds. When the motor current and motor voltage rise above or fall below the predetermined thresholds, the controller is configured to adjust the pulse width modulation (PWM) to adjust the power delivered by the battery pack 82 to the motor 34 to maintain the predetermined speed of the shoe 18. Accordingly, to maintain the predetermined output speed of the shoe 18, the power from the battery pack 82 will oscillate accordingly. This scenario gives a more consistent tool output but reduces the runtime of the battery pack 82.

To maintain a predetermined output power, the motor current and motor voltage are monitored based on predetermined thresholds. When the motor current and motor voltage rise above or fall below the predetermined thresholds, the controller is configured to adjust the pulse width modulation (PWM) to adjust the speed of the shoe 18, and therefore, the motor 34. Accordingly, the power from the battery pack 82 necessary to run the motor 34 may be the maintained at the predetermined output power. Accordingly, to maintain the predetermined output power of the battery pack 82, the speed of the shoe 18, and therefore the motor 34, will oscillate accordingly. This scenario increases the runtime of the battery pack 82 but risks variable tool output.

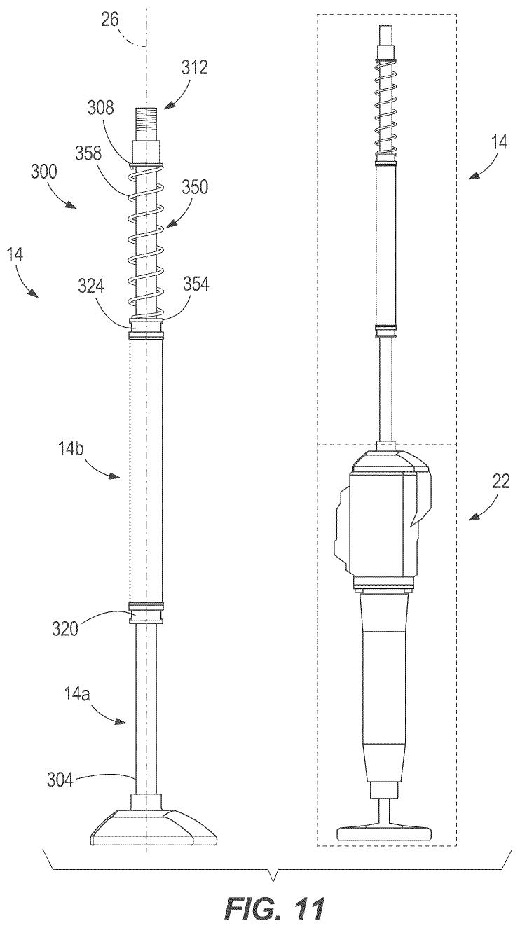

FIGS. 11-13 illustrated alternative embodiments for the handle 14 of any of the pole tamper embodiments herein. The use of the pole tampers 10 disclosed herein often results in significant vibration of the handle 14. Accordingly, the following handles 14 are configured to reduce vibration of the handle 14 using a vibration damping mechanism 300.

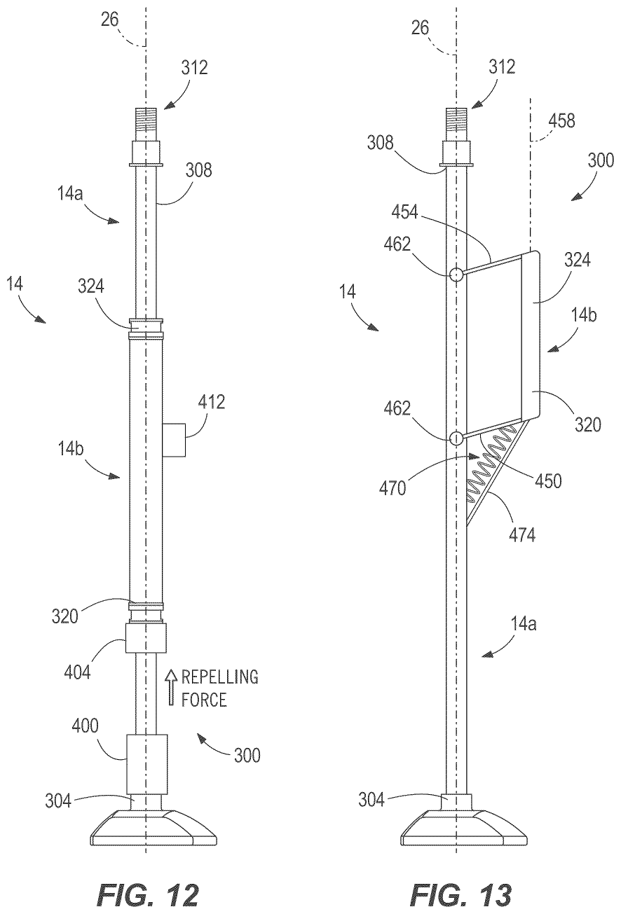

The handle of FIGS. 11-12 includes a first handle portion 14a, a second handle portion 14b, and a vibration damping mechanism 300. The first handle portion 14a is coupled to and extends from the percussion mechanism 20. The first handle portion 14a includes a first end 304 coupled to the percussion mechanism 22 and the second end 308 opposite the first end 304. In the illustrated embodiment, a cable connector 312 is coupled to the second end 308. The cable connector 312 is configured to couple to the cable 126 of any of the embodiments above of the remote power unit 122, as discussed above with respect to FIGS. 4-8. In other embodiments, the battery pack 82 may be coupled to the first handle portion 14a, as discussed above with respect to FIGS. 1-3. The first handle portion 14a is received within the second handle portion 14b. The second handle portion 14b includes a first end 320 and a second end 324 opposite the first end 320. In the illustrated embodiment, the first handle portion 14a extends through the second handle portion 14b. The first end 304 and the second end 308 of the first handle portion 14a are therefore positioned on opposite sides of the second handle portion 14b. The first end 304 of the first handle portion 14a is spaced apart from the first end 304 of the second handle portion 14b and the second end 308 of the first handle portion 14a is spaced apart from the second end 324 of the second handle portion 14b. As shown, the first handle portion 14a and the second handle portion 14b are aligned along the longitudinal axis 26 of the handle 14. The second handle portion 14b is movable along the longitudinal axis 26 and the length of the first handle portion 14a.

In embodiment of FIG. 11, the vibration damping mechanism 300 is a coil spring 350 that is positioned between the second end 324 of the second handle portion 14b and the second end 308 of the first handle portion 14a. A first end 354 of the spring is coupled to the second handle portion 14b and a second end 358 of the spring 350 is coupled to the first handle portion 14a adjacent the second end 308. When the percussion mechanism 22 is operating, the second handle portion 14b is movable along the length of the first handle portion 14a to reduce the vibrations experienced by the second handle portion 14b. The movement of the second handle portion is constrained by the spring 350. Depending on the implementation and load at a given time, the spring 350 could act in both tension and compression.

In an alternative embodiment, the spring 300 may be positioned between the first end 304 of the first handle portion 14a and the first end 320 second handle portion 14b. The first end 354 of the spring 300 may be coupled to the first handle portion 14a adjacent the first end 304 and the second end 358 of the spring 350 may be coupled to the first end 320 of the second handle portion 14b.

In yet another alternative embodiment, the vibration damping mechanism 300 may include a first coil spring and second coil spring. The first spring may be positioned between the first end 304 of the first handle portion 14a and the first end 320 of the second handle portion 14b. The first end of the first spring may be coupled to the first handle portion 14a adjacent the first end 304 and the second end of the first spring may be coupled to the first end 320 of the second handle portion 14b. The second spring may be positioned between the second end 324 of the second handle portion 14b and the second end 308 of the first handle portion 14a. The first end of the second spring may be coupled to the second handle portion 324 and the second end of the second spring may be coupled to the first handle portion 14a adjacent the second end 308. When the percussion mechanism 22 is operating, the second handle portion 14b is movable along the length of the first handle portion 14a to reduce the vibrations experienced by the second handle portion 14b. The movement is constrained by the springs.

The spring 350 of FIG. 11 and the alternatives to FIG. 11 may be replaced by a gas spring (not shown) in other embodiments.

In the embodiment of FIG. 12, the vibration damping mechanism 300 is a passive magnetic field provided by an assembly including an electromagnetic coil 400 and a permanent magnet 404. As shown, the electromagnetic coil 400 is coupled at or adjacent to the first end 304 of the first handle portion 14a and the permanent magnet 404 is coupled at or adjacent to the first end 320 of the second handle portion 14b. In an alternative embodiment, the permanent magnet 404 may be coupled at or adjacent to the first end 304 of the first handle portion 14a and the electromagnetic coil 400 may be coupled at or adjacent to the first end 320 of the second handle portion 14b. Regardless, the electromagnetic coil 400 is in communication with the controller of the motor control unit 86. The electromagnetic coil 400 is passive and energized by the controller when the tool is turned on. The electromagnetic coil 400 repels the permanent magnet 404.

In an alternative embodiment to FIG. 12, the vibration damping mechanism 300 may include two assemblies, each having an electromagnetic coil and a permanent magnet. For example, a first electromagnetic coil may be coupled at or adjacent to the first end 304 of the first handle portion 14a and a first permanent magnet may be coupled at or adjacent to the first end 320 of the second handle portion 14a. Also, a second electromagnetic coil may be coupled at or adjacent to the second end 308 of the first handle portion 14a and a second permanent magnet may be coupled at or adjacent to the second end 324 of the second handle portion 14b. The positions of the electromagnetic coils and the permanent magnets may also be reversed in another alterative embodiment. Regardless, the electromagnetic coils are in communication with the controller of the motor control unit 86. The electromagnetic coils are passive and energized by the controller when the tool is turned on. The electromagnetic coils repel the permanent magnets.

As shown in FIG. 12, in some embodiments, the vibration damping mechanism 300 may further include an accelerometer 412 supported by the second handle portion 14b. The accelerometer 412 is configured to communicate with the controller in the motor control unit 86. The accelerometer 412 is configured to sense the movement of the second tube portion 14b while the percussion mechanism 22 operates. In response, the controller is configured to vary the magnetic field in the electromagnetic coil 400 (or in both the electromagnetic coils) to minimize acceleration due to vibration experienced by the second handle portion 14b.

The handle 14 of FIG. 13 includes a first handle portion 14a, a second handle portion 14b, a first linkage 450, and a second linkage 454. The first handle portion 14a includes the first longitudinal axis 26 and the second handle portion 14b that defines a second longitudinal axis 458. The second longitudinal axis 458 is parallel to the first longitudinal axis 26. In the illustrated embodiment, the second end 308 of the first handle portion 14a includes the cable connector 312, which is configured to couple to the cable 126 of any of the embodiments above of the remote power unit 122, as discussed above with respect to FIGS. 4-8. In other embodiments, the battery pack 82 may be coupled to the first handle portion 14a, as discussed above with respect to FIGS. 1-3. The first linkage 450 couples the first end 320 of the second handle portion 14b to the first handle portion 14a and the second linkage 454 couples the second end 324 of the second handle portion 14b of the first handle portion 14a. The first handle portion 14a, the second handle portion 14b, the first linkage 450, and the second linkage 454 define a four-bar linkage (e.g., a linkage system), as shown. The first and second linkages 450, 454 provide the vibration damping mechanism 300 to the handle 14.

In some embodiments, the vibration dampening mechanism 300 also includes linkage isolators 462 (e.g., elastomeric isolators). Each of the first and second linkage 450, 454 may include a linkage isolator 462. In some embodiments, each linkage isolator 462 may be positioned between the corresponding linkage 450, 454 and the first handle portion 14a. In other embodiments, each linkage isolator 462 may be positioned between the corresponding linkage 450, 454 and the second handle portion 14b.

In the illustrated embodiment, the first and second linkages 450, 454 are pivotally coupled to the first handle portion 14a along the first longitudinal axis 26. In other words, the first linkage 450 is coupled to the first handle portion 14a at a first position along the longitudinal axis 26 and the second linkage 454 is coupled to the first handle portion 14a at a second position along the longitudinal 26, which is a distance from the first position. Further, the length of the second handle portion 14b may be equal to the distance between the first and second positions at which the first and second linkages 450, 454 are pivotally coupled to the first handle portion 14a. As a result, the second handle portion 14b may move primarily parallel to and along the second longitudinal axis 458. The range of motion of the vibration dampening mechanism 300 may be limited by a lower stop position, where the second handle portion 14b contacts the first handle portion 14a, and an upper stop position, where the second handle portion 14b also contacts the first handle portion 14a. The linkage isolators 462 are also configured to restrict movement of the linkages 450, 545 near the upper and lower stop positions. In other words, the linkage isolators 462 are configured to absorb forces from the translational movement of the second handle portion 14b along the second longitudinal axis 458 near the upper and lower stop positions, thereby protecting the user's hand from vibration.

In alternative embodiment of FIG. 13, the vibration dampening mechanism 300 additionally or alternatively may include a spring 470 and a damper 474, which are coupled to and extend between the linkage system and the first handle portion 14a. In the illustrated embodiment, the spring 470 and the damper 474 may each be coupled to the lower, second linkage 454. In other embodiments, the spring 470 and damper 474 may be coupled to any combination of the other linkages of the linkage system (e.g., the first linkage 450, the second handle portion 14b). Further, the spring 470 and damper may have a linear relation. The combination of the spring 470 and damper 474 are configured to attenuate vibration to the second handle portion 14b. The range of motion of the second handle portion 14b may be limited to the lower and upper stop positions discussed above. In other words, the spring 470 and damper 474 are configured to absorb forces from the translational movement of the second handle portion 14b along the second longitudinal axis 458 near the upper and lower stop positions, thereby protecting the user's hand from vibration.

In yet another alternative embodiment of FIG. 13, the first and second linkage 454s may additionally or alternatively include metal, plastic, or composite leaf springs (not shown), rather than linkage isolators 462 and/or spring 470 and damper 474. In yet alternative embodiment of FIG. 13, the first and second linkage 454s may each include a gas spring (not shown), rather than linkage isolators 462 and/or the spring 470 and damper 474. In either of these embodiments, the leaf spring or the gas springs are configured to absorb forces from the translational movement of the second handle portion 14b along the second longitudinal axis 458 near the upper and lower stop positions, thereby protecting the user's hand from vibration.

In yet another alternative embodiment of FIG. 13 (not shown), a secondary motor may be coupled between one of the first and second linkage 450, 454 and the first handle portion 14a. The vibration dampening mechanism 300 may also include a spring 470 and a damper 474, which are each coupled to and extend between the linkages 450, 454 and the first handle portion 14a. The spring 470 and damper 474, if included, are similar to those discussed above. The secondary motor may be a servo motor that is configured to control the position of the second handle portion 14b along the second longitudinal axis 458, in response to a signal from the controller of the motor control system 86. For example, the motor control system may detect a property (e.g., speed, position, etc.) of the second handle portion 14b and may send a signal to the secondary motor to attenuate the vibration on the second handle portion 14b. As such, the combination of the spring 470, the damper 474, and the secondary motor are configured to attenuate vibration to second handle portion 14b.

Although the invention has been described in detail with reference to certain preferred embodiments, variations and modifications exist within the scope and spirit of one or more independent aspects of the invention as described.

Various features of the invention are set forth in the following claims.

What is claimed is:

1. A pole tamper comprising:
a handle;
a motor supported by the handle and operably coupled to a battery pack to receive electrical current therefrom;
a shoe movably supported by the handle; and
a drive mechanism operably coupled to the motor, the drive mechanism configured to move the shoe in a reciprocating manner.

2. The pole tamper of claim 1, wherein the drive mechanism includes a piston and the shoe is directly coupled to the piston.

3. The pole tamper of claim 1, wherein the drive mechanism includes a piston, wherein the pole tamper further comprises a housing coupled to the shoe and a spring, and wherein the piston is received within the housing and engaged with the spring.

4. The pole tamper of claim 1, further comprising a battery receptacle supported by the handle and configured to couple to the battery pack.

5. The pole tamper of claim 4, further comprising a motor control unit supported by the handle and configured to communicate with the motor.

6. The pole tamper of claim 1, further comprising:
a remote power unit that is unsupported by the handle and to which the battery pack is attachable; and
a cable configured to transmit electrical current from the battery pack to the motor.

7. The pole tamper of claim 6, further comprising a motor control unit supported by the handle and configured to communicate with the motor and the remote power unit.

8. The pole tamper of claim 6, wherein the remote power unit includes a motor control unit configured to transmit electrical power and control signals to the motor via the cable.

9. The pole tamper of claim 1, further comprising a wireless remote configured to operate the motor.

10. The pole tamper of claim 1, further comprising an active gyroscope supported by the handle and configured to maintain the handle in an upright position.

11. The pole tamper of claim 1, further comprising a tip detect sensor supported by the handle and configured to deactivate the motor in response to detection of the handle deviating from a substantially upright position.

12. The pole tamper of claim 11, wherein the tip detect sensor includes a gyroscope or an accelerometer.

13. A pole tamper comprising:
a handle;
a motor supported by the handle;
a shoe supported by the handle;
a drive mechanism operably coupled to the motor, the drive mechanism configured to move the shoe in a reciprocating manner;
a remote power unit unsupported by the handle; and
a cable configured to transmit electrical current from the remote power unit to the motor.

14. The pole tamper of claim 13, further comprising a motor control unit supported by the handle and configured to communicate with the motor and the remote power unit.

15. The pole tamper of claim 13, wherein the remote power unit includes a motor control unit configured to transmit electrical power and control signals to the motor via the cable.

16. The pole tamper of claim 13, further comprising a tip detect sensor supported by the handle and configured to deactivate the motor in response to detection of the handle deviating from a substantially upright position.

17. A pole tamper comprising:
a handle;
a motor supported by the handle;
a shoe supported by the handle;
a drive mechanism operably coupled to the motor, the drive mechanism configured to move the shoe in a reciprocating manner; and
a tip detect sensor supported by the handle and configured to deactivate the motor in response to detection of the handle deviating from a substantially upright position.

18. The pole tamper of claim 17, further comprising:
a battery receptacle supported by the handle and configured to couple to a battery pack; and
a motor control unit supported by the handle and configured to communicate with the motor.

19. The pole tamper of claim 17, further comprising:
a remote power unit that is unsupported by the handle and to which a battery pack is attachable;
a cable configured to transmit electrical current from the battery pack to the motor; and
a motor control unit configured to communicate with the motor and that is either supported by the handle or the remote power unit.

20. The pole tamper of claim 17, wherein the tip detect sensor includes a gyroscope or an accelerometer.
